(19) United States
(12) Patent Application Publication
(10) Pub. No.: US 2025/0384564 A1
(43) Pub. Date: Dec. 18, 2025

(54) PROCESSING DEVICE, PROCESSING METHOD, AND RECORDING MEDIUM

(71) Applicant: CANON KABUSHIKI KAISHA, Tokyo (JP)

(72) Inventor: SATOKO SAITO, Kanagawa (JP)

(21) Appl. No.: 19/238,217

(22) Filed: Jun. 13, 2025

(30) Foreign Application Priority Data
Jun. 18, 2024 (JP) 2024-098012

(51) Int. Cl. G06T 7/246; G06T 7/73

(52) U.S. Cl. CPC G06T 7/246; G06T 7/73; G06T 2207/10016; G06T 2207/30196

(57) ABSTRACT

A processing device includes one or more memories, and one or more processors in communication with the one or more memories, wherein the one or more processors and the one or more memories are configured to extract, from a captured moving image, a section where an angle of view of an imaging apparatus continuously moves, derive object information indicating a description according to a feature of an object in the extracted section, derive, based on the derived object information, first section information for identification of a state where the section included in the moving image is a section where an object is tracked, or second section information for identification of a state where the section included in the moving image is a section where no object is tracked and output the second section information.

### BACKGROUND OF THE DISCLOSURE

### Field of the Disclosure

The present disclosure relates to a processing device, a processing method, and a recording medium.

### Description of the Related Art

There is a case where a moving image captured by an imaging apparatus is displayed, edited, and managed. Japanese Patent Application Laid-Open No. 8-191411 discusses a method for distinguishing from a moving image a scene where a user (a photographer) continuously moves an imaging apparatus in a constant direction. Specifically, Japanese Patent Application Laid-Open No. 8-191411 discusses a method for distinguishing whether the imaging apparatus is moved to track an object or the imaging apparatus is moved to shift the line of sight to another object by the user in this scene.

However, in the technique discussed in Japanese Patent Application Laid-Open No. 8-191411, a correlation image between frames compensated using a motion vector is detected, and the above distinctions are made based on the degree of concentrated presence of regions with low correlations in the correlation image. Thus, for example, in a case where the action of an object changes when the imaging apparatus is tracking the object, it may be distinguished that the imaging apparatus is moved to shift the line of sight to another object by the user even though the imaging apparatus is tracking the object. In this case, for example, it may not be possible to correctly distinguish the sequential action of the same object as a single scene.

### SUMMARY OF THE DISCLOSURE

In view of the above issue, the present disclosure is directed to improving the accuracy of the distinction of whether a scene is a scene where an imaging apparatus tracks an object.

According to an aspect of the present disclosure, a processing device includes one or more memories, and one or more processors in communication with the one or more memories, wherein the one or more processors and the one or more memories are configured to extract, from a captured moving image, a section where an angle of view of an imaging apparatus continuously moves, derive object information indicating a description according to a feature of an object in the extracted section, derive, based on the derived object information, first section information for identification of a state where the section included in the moving image is a section where an object is tracked, or second section information for identification of a state where the section included in the moving image is a section where no object is tracked and output the second section information.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a processing system.

FIG. 2 is a diagram illustrating a configuration of an information processing apparatus.

FIG. 3 is a diagram illustrating a situation where a plurality of objects is repeatedly captured.

FIG. 4 is a diagram illustrating a scene list.

FIG. 5 is a flowchart illustrating an example of a processing method.

FIG. 6 is a diagram illustrating an image management screen.

### DESCRIPTION OF THE EMBODIMENTS

The following describes an embodiment of the present disclosure with reference to the accompanying drawings.

### Example of System Configuration

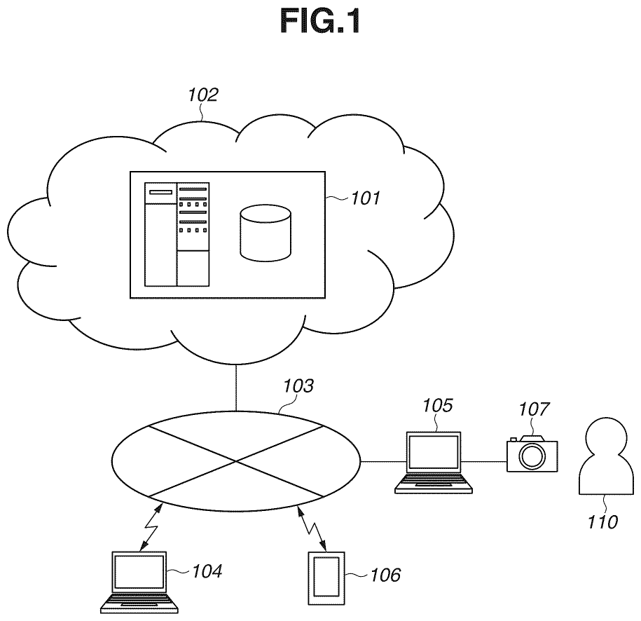

FIG. 1 is a diagram illustrating an example of the configuration of a processing system according to the present embodiment.

In FIG. 1, in the present embodiment, a case is illustrated where the processing system includes an information processing apparatus 101. FIG. 1 illustrates a case where the information processing apparatus 101 operates in a cloud 102. FIG. 1 illustrates a case where the information processing apparatus 101 is connected to an external apparatus via a network 103 so that the information processing apparatus 101 and the external apparatus can communicate with each other. In the present embodiment, a case is illustrated where the network 103 includes the Internet. FIG. 1 illustrates a case where the processing system includes personal computers (PCs) 104 and 105, a mobile device 106, and an imaging apparatus 107. FIG. 1 illustrates a case where the imaging apparatus 107 is connected to the PC 105 so that the imaging apparatus 107 and the PC 105 can communicate with each other, and information stored in the imaging apparatus 107 is transmitted to an external apparatus (e.g., the information processing apparatus 101) via the PC 105. The present disclosure, however, is not necessarily limited to this. For example, the information stored in the imaging apparatus 107 may be directly transmitted from the imaging apparatus 107 to the external apparatus.

In the present embodiment, a case is illustrated where the imaging apparatus 107 is an apparatus capable of capturing a moving image, such as a video camera. At least one apparatus among the PCs 104 and 105, the mobile device 106, and the imaging apparatus 107 may not be included in the processing system. In a case where the imaging apparatus 107 is not included in the processing system, for example, the information processing apparatus 101 may read data of a moving image captured by the imaging apparatus 107 from a portable storage medium storing the data of the moving image.

In the processing system illustrated in FIG. 1, for example, a moving image captured by the imaging apparatus 107 may be uploaded to the information processing apparatus 101 as described below. First, a user 110 such as an owner of the imaging apparatus 107 operates the imaging apparatus 107, thereby causing the imaging apparatus 107 to capture a moving image. For example, the user 110 operates the imaging apparatus 107 and the PC 105, thereby storing data of the moving image captured by the imaging apparatus 107 in the PC 105. Then, the user 110 operates the PC 105, thereby uploading the data of the moving image captured by the imaging apparatus 107 to the information processing apparatus 101 (an image management application) via the network 103. As described above, for example, the data of the moving image captured by the imaging apparatus 107 may be uploaded using the imaging apparatus 107.

In the processing system illustrated in FIG. 1, in a case where the user 110 uses a moving image uploaded to the information processing apparatus 101, the user 110 may operate a terminal apparatus, thereby accessing the image management application on the information processing apparatus 101 via the network 103. In FIG. 1, for example, the terminal apparatus is at least one of the PCs 104 and 105 and the mobile device 106. In this case, by using the terminal apparatus, the user 110 can view and edit a moving image managed by the image management application.

In the present embodiment, a case is illustrated where the user 110 as an owner of a moving image uploads the moving image to the image management application installed on the information processing apparatus 101 operating in the cloud 102, and views and edits the moving image. The present disclosure, however, is not necessarily limited to this. For example, the information processing apparatus 101 (the image management application) does not need to be in the cloud 102, and may be in an on-premises environment. The image management application may be read and executed by the terminal apparatus (the PC 104 or 105 or the mobile device 106). In this case, for example, the terminal apparatus may directly load a moving image from the imaging apparatus 107, and may perform processing similar to that of the information processing apparatus 101 and allow the user 110 to view and edit the moving image by using the image management application. The network 103 is not limited to the Internet. The network 103 may include another network such as a local area network (LAN) in addition to or instead of the Internet. The network 103 may be a wired communication network, or may be a wireless communication network, or may be a network including both a wired communication network and a wireless communication network. A communication line other than a network may be used in addition to or instead of the network 103.

A user and an owner of the image management application do not need to be the same as each other. For example, by using the terminal apparatus, the user 110 may be able to view and edit a moving image owned by another person (another user). In this case, for example, the information processing apparatus 101 may perform user authentication for at least one of the viewing and the editing of the moving image. In this case, the information processing apparatus 101 may permit only a user successfully authenticated in the user authentication to perform at least one of the viewing and the editing of the moving image in the range of authority given to the user. Such user authentication, however, may not be performed.

### Example of Configuration of Information Processing Apparatus (Image Management Application)

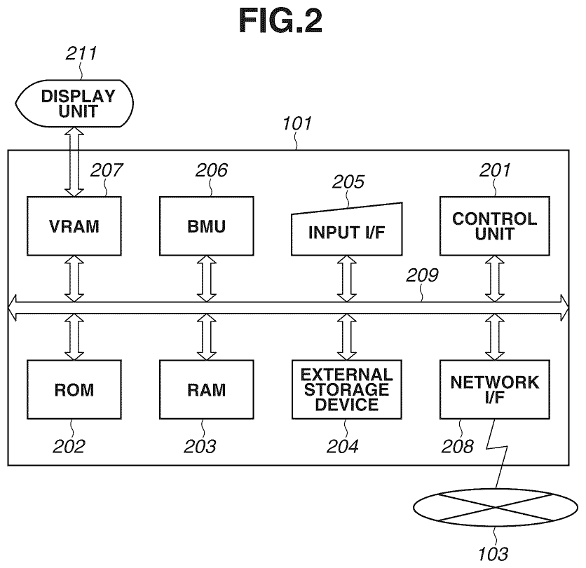

FIG. 2 is a diagram illustrating an example of the configuration of the information processing apparatus 101 according to the present embodiment. The information processing apparatus 101 may be achieved by a single computer apparatus. The functions of the information processing apparatus 101 may be dispersed into a plurality of computer apparatuses, where necessary. In a case where the functions of the information processing apparatus 101 are achieved by a plurality of computer apparatuses, the plurality of computer apparatuses is connected to each other by a communication line such as a LAN so that the plurality of computer apparatuses can communicate with each other. For example, the terminal apparatuses (the PCs 104 and 105 and the mobile device 106 in the example illustrated in FIG. 1) other than the information processing apparatus 101 can also be achieved by the configuration illustrated in FIG. 2. Thus, the apparatuses other than the information processing apparatus 101 are not described in detail here. For example, the imaging apparatus 107 is achieved by including an imaging unit for capturing a moving image in addition to the configuration illustrated in FIG. 2. For example, the imaging unit includes an imaging optical system including an imaging lens, and an imaging element. The configuration itself of the imaging unit is achieved by a known technique, and therefore is not described in detail here.

In FIG. 2, a control unit 201 controls the entirety of the information processing apparatus 101. For example, the control unit 201 includes a central processing unit (CPU). The control unit 201 may include one or more processors (e.g., graphics processing units (GPUs)) different from the CPU, in addition to or instead of the CPU. The processing of the control unit 201 may be performed by a plurality of pieces of hardware sharing the processing. At least a part of the processing of the control unit 201 may be performed by using dedicated hardware. For example, the dedicated hardware is an application-specific integrated circuit (ASIC) and a field-programmable gate array (FPGA). Also, in the apparatuses other than the information processing apparatus 101, similarly, as described above, a processor may not be limited to a particular processor (e.g., a CPU), a plurality of pieces of hardware may share processing, and dedicated hardware may be used.

A read-only memory (ROM) 202 stores a program and a parameter that do not need to be changed. A random-access memory (RAM) 203 temporarily stores a program and data supplied from an external apparatus. An external storage device 204 is a hard disk or a memory card fixedly installed in the information processing apparatus 101. For example, the external storage device 204 stores a program for an operating system (OS). An input interface (I/F) 205 connects the information processing apparatus 101 to an input device (not illustrated). The input device receives an operation of the user 110 and inputs data. For example, the input device includes at least one of a pointing device and a keyboard. For example, a bit move unit (BMU) 206 controls data transfer between memories (e.g., between a video random-access memory (VRAM) 207 and another memory) or between a memory and each input/output (I/O) device (e.g., a network I/F 208).

The VRAM 207 draws an image to be displayed on a display unit 211. The VRAM 207 transmits an image including various pieces of information to the display unit 211 according to a predetermined rule.

Consequently, the display unit 211 displays the various pieces of information. The display unit 211 includes a computer display such as a liquid crystal display. In the present embodiment, a case is illustrated where information displayed on the display unit 211 includes information required for the user 110 to view and edit a moving image captured by the imaging apparatus 107. There is a case where the display unit 211 displays information different from a moving image captured by the imaging apparatus 107 and information for editing the moving image. The network I/F 208 connects the information processing apparatus 101 to a communication line. In the present embodiment, a case is illustrated where the network I/F 208 connects the information processing apparatus 101 to the network 103. A system bus 209 connects the units (the control unit 201 to the network I/F 208) included in the information processing apparatus 101 so that the units can communicate with each other.

### Description of Example of Capturing of Moving Image

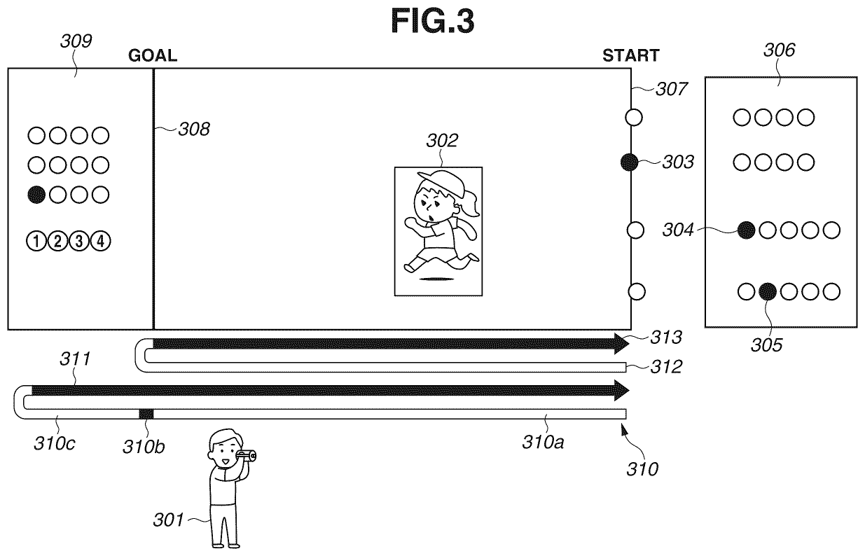

FIG. 3 is a diagram illustrating an example of a situation where a plurality of objects is repeatedly captured. FIG. 3 illustrates a situation where objects running on a straight section of a track in an athletic field are repeatedly captured. Specifically, in the situation illustrated in FIG. 3, objects 302, 303, 304, and 305 as runners run in order on the track in the athletic field, and a photographer 301 captures each of the objects 302, 303, 304, and 305 while tracking the object using the imaging apparatus 107. In the following description, the capturing of an object while tracking the object is referred to as “tracking imaging”, where necessary. A period when tracking imaging is performed includes a period when the angle of view of the imaging apparatus 107 continuously moves. The continuous movement of the angle of view of the imaging apparatus 107 corresponds to the continuous change in the direction of the imaging apparatus 107.

In a case where tracking imaging is performed, normally, an object is in focus. However, there is also a case where an object is out of focus even though the photographer 301 intends to track the object. That is, there is also a case where no object is in focus in a case where tracking imaging is performed. In the present embodiment, a case is illustrated where an object as a tracking target is in focus. However, objects as tracking targets may include an object out of focus. In this case, in a case where an object appears anywhere in the entire region in an image, it may be considered that tracking imaging is performed. In the present embodiment, a case is illustrated where an object as a tracking target is a person. However, an object as a tracking target may be a physical body other than a person. For example, an object may be a living object (e.g., an animal, a bird, or an insect) other than a person, or a moving object such as a vehicle (e.g., a car, an airplane, or a train).

In FIG. 3, the objects 304 and 305 are waiting in a pre-contest waiting place 306. The object 303 is at a starting position 307 of a track-and-field contest. The object 302 is in the middle of running from the starting position 307 to a goal position 308 of the track-and-field contest. After each runner finishes the track-and-field contest, the runner waits in a post-contest waiting place 309. Circled numbers illustrated in the waiting place 309 indicate the order of arrival. FIG. 3 illustrates a case where each runner after the contest waits at a position according to the place of the runner in the order of arrival.

In FIG. 3, sections 310 to 313 each indicate a section where the angle of view of the imaging apparatus 107 continuously moves. In the sections 310 to 313, a low-density portion indicates a period when an object is in focus, and a high-density portion indicates a period when no object is in focus.

The direction in which the angle of view moves may be any direction. The direction in which the angle of view moves may be a left-right direction (a pan direction) of the imaging apparatus 107, or may be an up-down direction (a tilt direction) of the imaging apparatus 107, or may be a direction (e.g., an oblique direction) different from these directions. The direction in which the angle of view moves may be a constant direction. The constant direction may not be exactly the same direction. For example, in a case where a captured image includes an object as a tracking target, it may be considered that the angle of view is moving in the constant direction. The constant direction may include a plurality of directions. In a case where tracking imaging is performed, the direction in which the angle of view moves may be the direction in which an object moves. The direction in which the angle of view moves may not be exactly the same direction as the direction in which the object moves. For example, in a case where a captured image includes an object as a tracking target, it may be considered that the angle of view is moving in the direction in which the object moves. The direction in which the angle of view moves may be a direction opposite to the direction in which an object moves. In a case where tracking imaging is performed, generally, the photographer 301 shifts the line of sight according to the motion of an object without changing the place where the photographer 301 themselves is. Thus, in a case where tracking imaging is performed, generally, the angle of view of the imaging apparatus 107 moves (the direction of the imaging apparatus 107 changes) in the state where the position of the imaging apparatus 107 does not (greatly) change. The imaging magnification may or may not change when the angle of view continuously moves.

In the situation illustrated in FIG. 3, the angle of view continuously may move from the starting position 307 to the goal position 308 and the waiting place 309. Also, in the situation illustrated in FIG. 3, the angle of view may continuously move from the goal position 308 to the starting position 307 and the waiting place 306.

In the present embodiment, a description will be given of a case where the angle of view continuously moves by the photographer 301 themselves changing the direction of the imaging apparatus 107 to track an object. However, for example, a technique according to the present embodiment may be applied to a case where the angle of view continuously moves by the imaging apparatus 107 automatically tracking an object.

In FIG. 3, first, in the state where the imaging apparatus 107 is focused on the object 302, the object 302 is subjected to tracking imaging from the starting position 307 to the goal position 308 (see a partial section 310a (a low-density portion) of the section 310). Then, the tracking of the object 302 is interrupted once at the goal position 308 (see a partial section 310b (a high-density portion) of the section 310). In the partial section 310b, no object is in focus. Then, in the state where the object 302 continues to be in focus from when the object 302 finishes the contest to when the object 302 starts waiting in the post-contest waiting place 309, the object 302 is subjected to tracking imaging (see a partial section 310c of the section 310). Then, to capture the next object 303, the photographer 301 rapidly moves the angle of view of the imaging apparatus 107 toward the starting position 307 in the state where no object is tracked. Then, the photographer 301 returns the angle of view of the imaging apparatus 107 to the starting position 307 (see the section 311). In the section 311, no object is in focus.

Then, in the state where the imaging apparatus 107 is focused on the object 303 (see the section 312), the object 303 is subjected to tracking imaging from the starting position 307 to the goal position 308. Then, to capture the next object 304, the photographer 301 rapidly moves the angle of view of the imaging apparatus 107 toward the starting position 307 in the state where no object is tracked. Then, the photographer 301 returns the angle of view of the imaging apparatus 107 to the starting position 307 (see the section 313). The object 305 is also subjected to tracking imaging similarly to the case where the object 304 is subjected to tracking imaging.

FIG. 3 illustrates a case where the imaging apparatus 107 captures a sequential moving image in which the objects 302, 303, 304, and 305 are subjected to tracking imaging one after another in the above flow.

A description is given below of an example of processing including determining portions where the same object is tracked in a moving image in which a plurality of objects is continuously tracked as a single scene, and determining an unnecessary scene between scenes where objects are tracked. The unnecessary scene (i.e., a scene where no object is tracked) may be deleted from the moving image. At this time, it is desirable to reduce the trouble of the work of deleting the unnecessary scene from the moving image. Accordingly, a description is also given below of a process of deleting the unnecessary scene from the moving image, and a process for reducing the trouble of the work of deleting the unnecessary scene from the moving image.

The processing of the information processing apparatus 101 in the following description is achieved by, for example, the control unit 201 reading the image management application from the ROM 202, the external storage device 204, or the network I/F 208 and executing the image management application. The processing of each of the terminal apparatuses other than the information processing apparatus 101 is achieved by, for example, the control unit included in the terminal apparatus reading and executing a program stored in the ROM or the external storage device. In the following description, a section where the angle of view of the imaging apparatus 107 continuously moves in a moving image is referred to as an “angle-of-view movement section”, where necessary. There is a case where the angle-of-view movement section includes a section where tracking imaging is performed, and a case where the angle-of-view movement section includes a section where tracking imaging is not performed.

### Example of Table That Stores Analysis Results of Moving Image

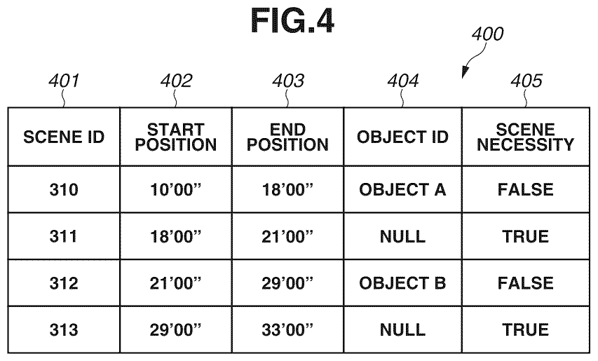

FIG. 4 is a diagram illustrating an example of a scene list 400. The scene list 400 is an example of information used by the information processing apparatus 101 (the image management application) to manage an angle-of-view movement section (a scene) included in a moving image. In the present embodiment, a case is illustrated where the scene list 400 is a table that stores information regarding a scene included in the moving image. Specifically, in the present embodiment, a case is illustrated where information regarding a single angle-of-view movement section extracted from the moving image is stored as information regarding a single scene in the scene list 400. More specifically, in the present embodiment, a case is illustrated where a scene identifier (ID) 401, a start position 402, an end position 403, an object ID 404, and scene necessity 405 are included as information (column information) regarding a single scene.

The column of the scene ID 401 stores a scene ID automatically issued when the column is created. The scene ID is an example of identification information regarding the scene.

The column of the start position 402 stores information indicating the timing when the scene identified by the scene ID starts. For example, the column of the start position 402 stores the time elapsed since the moving image starts.

The column of the end position 403 stores information indicating the timing when the scene identified by the scene ID ends. For example, the column of the end position 403 stores the time elapsed since the moving image starts.

The column of the object ID 404 stores information based on the result of individually identifying an object in focus in the scene identified by the scene ID. The column of the object ID 404 may store an ID that uniquely identifies the object. The column of the object ID 404 may store information associated with the feature amount of the object. In this case, for example, the feature amount of the object may be the feature amount of the face. The feature amount of the object may be the feature amount of information that allows the identification of the object, such as the number cloth or the number of the object. For example, the column of the object ID 404 may store information obtained by quantifying the analysis result of the feature amount of the object. In the following description, this result is referred to as “feature analysis information”, where necessary. For example, the feature analysis information may be information obtained by quantifying the analysis result of the feature amount of a person. In this case, for example, the feature analysis information may be the ratios of the sizes of the eyes, the nose, and the mouth to the size of the face. The sizes may be areas or lengths. The feature analysis information may be information obtained by quantifying the analysis result of the feature amount of a physical body other than a person. The analysis result of the feature amount of the object (a person or a physical body) may be quantified based on the analysis result by artificial intelligence (AI) that performs individual identification. These pieces of feature analysis information may be associated with the feature amount of the object. An ID that uniquely identifies the object may be associated with the feature amount of the object. As described above, object information may be an ID, a feature amount, or other information as long as the object information is information indicating a description according to the feature of the object.

The column of the scene necessity 405 may store information indicating whether the scene identified by the scene ID is an unnecessary scene. FIG. 4 illustrates a case where the column of the scene necessity 405 stores “FALSE” in a case where the scene identified by the scene ID is not an unnecessary scene. On the other hand, FIG. 4 illustrates a case where the column of the scene necessity 405 stores “TRUE” in a case where the scene identified by the scene ID is an unnecessary scene.

FIG. 4 illustrates a case where information regarding the scenes of the sections 310 to 313 illustrated in FIG. 3 is stored in the scene list 400.

### Example of Processing Including Analysis of Moving Image

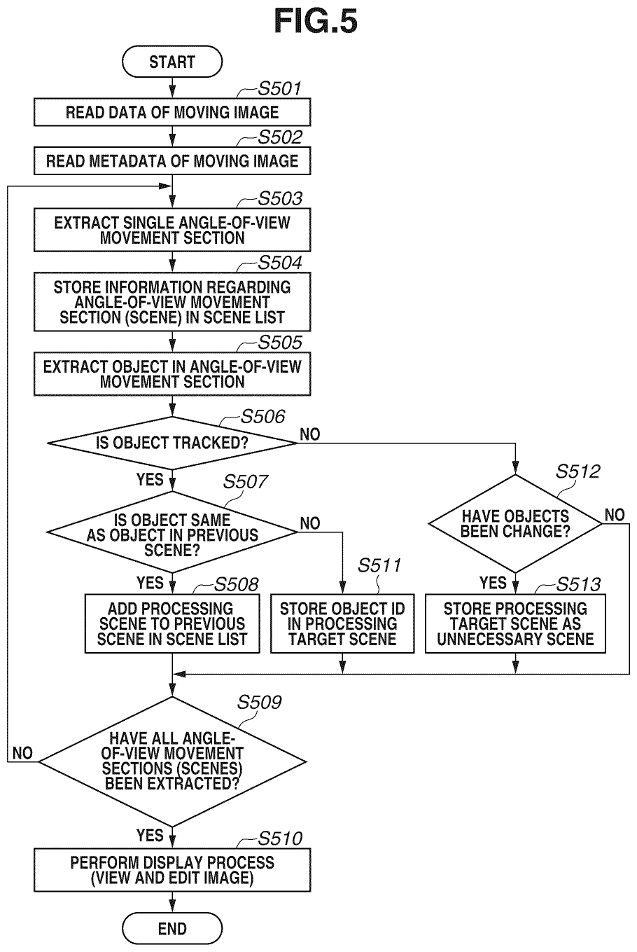

With reference to a flowchart in FIG. 5, an example of a processing method performed by the information processing apparatus 101 is described. In the flowchart in FIG. 5, a case is illustrated where processing including determining each of angle-of-view movement sections included in a sequential moving image captured by the imaging apparatus 107 as a single scene, and analyzing each scene is performed. The analysis of the scene includes distinguishing which of a scene where tracking imaging is performed and a scene where tracking imaging is not performed the scene is. As described above, a case is illustrated where the processing in the flowchart in FIG. 5 is executed by the control unit 201 reading and executing the image management application. The flowchart in FIG. 5 may start, for example, in a case where an operation for giving an instruction to start the image management application is performed on the input I/F 205. The flowchart in FIG. 5 may start, for example, after the image management application starts, and in a case where an operation for specifying a file of a moving image as an analysis target is performed on the input I/F 205. For ease of description, a case is illustrated where the file of the moving image as the analysis target is uploaded to the information processing apparatus 101 (the image management application) before the processing in the flowchart in FIG. 5 starts.

In step S501, the control unit 201 reads data of the moving image as the analysis target.

In step S502, the control unit 201 reads metadata of the moving image as the analysis target. In the present embodiment, a case is illustrated where, for example, the metadata of the moving image stores the start timing and the end timing of an angle-of-view movement section (a section where the angle of view of the imaging apparatus 107 continuously moves) in the moving image as the analysis target. In the present embodiment, a case is illustrated where the imaging apparatus 107 creates metadata of a moving image and adds the metadata to the moving image. The number of angle-of-view movement sections included in the moving image as the analysis target may be at least one, or may be two or more.

In the present embodiment, a case is illustrated where the control unit 201 determines the start timing and the end timing of an angle-of-view movement section based on information stored in the metadata created by the imaging apparatus 107. The present disclosure, however, is not necessarily limited to this. For example, the control unit 201 may determine the start timing and the end timing of an angle-of-view movement section based on the state where the angle of view of the imaging apparatus 107 is moving according to the movement of an object, or the result of the image analysis of each frame image.

In step S503, the control unit 201 extracts a single angle-of-view movement section from the moving image as the analysis target. In the present embodiment, a case is illustrated where based on the start timings and the end timings of angle-of-view movement sections, the control unit 201 extracts a single angle-of-view movement section of which the start timing is the earliest among angle-of-view movement sections that are included in the moving image as the analysis target and have not yet been extracted. If, however, an angle-of-view movement section that is included in the moving image as the analysis target and has not yet been extracted is extracted in step S503, the present disclosure is not necessarily limited to this. To increase the accuracy of the analysis of a scene, the extraction conditions for an angle-of-view movement section may include that an object is moving in the same direction.

In step S504, the control unit 201 determines an image of the angle-of-view movement section extracted in step S503 as a single scene and stores the scene ID 401, the start position 402, and the end position 403 as information regarding the scene in the scene list 400.

In step S505, with respect to each frame image included in in the angle-of-view movement section extracted in step S503, the control unit 201 extracts an object from a region in focus in the frame image included in the angle-of-view movement section. For example, the control unit 201 may extract an object from the region in focus in the frame image by analyzing the frame image using an image analysis library. For example, in a case where metadata of each frame image of the moving image as the analysis target includes identification information regarding an object, the control unit 201 may extract the object from the region in focus in the frame image by using the identification information. There is a case where an object is not present in the region in focus in the frame image. In this case, the control unit 201 determines that there is not an object to be extracted from the frame image, and performs the processes of subsequent steps. For example, in a case where an object is not present in the region in focus, the determination will be NO in step S506. In a case where an object is not present in the region in focus, the feature amount of an object is not derived (or the absence of the feature amount of an object may be derived).

In step S506, based on the extraction result of the object in step S505, the control unit 201 determines whether a particular object is tracked. The determination of whether a particular object is tracked may be the determination of whether a particular type of object (e.g., a person) is tracked. The determination of whether a particular object is tracked may be the determination of whether an object registered in advance is tracked.

In the determination in step S506, the control unit 201 may derive the feature amount of the object extracted in step S505 and perform individual identification based on the feature amount of the object. In this case, the control unit 201 may issue an object ID corresponding to the result of the individual identification. As described above, for example, the feature amount of the object may be the feature amount of the face, or may be the feature amount of information that allows the identification of the object, such as the number cloth or the number of the object. For example, the individual identification may be performed by using an image analysis library included in the image management application, or may be performed by using an image analysis library in an external server. The individual identification may be performed by using AI (e.g., a machine learning model).

The control unit 201 may compare the region in focus in the frame image and a template image, thereby determining whether an object corresponding to the template image appears in the region. Regardless of whether the target is the region in focus, the control unit 201 may compare the frame image and a template image, thereby determining whether an object corresponding to the template image appears in the frame image.

For example, a process of dividing the single angle-of-view movement section (the single scene) into a plurality of angle-of-view movement sections (scenes) may be included between steps S505 and S506.

For example, in a case where the angle-of-view movement section extracted in step S503 includes a single frame image or a plurality of continuous frame images in which an object is not extracted in step S505, the control unit 201 may divide the angle-of-view movement section (the scene) into a plurality of angle-of-view movement sections (scenes) as described below. That is, the control unit 201 may determine each of the section of the frame image, the section of a frame image before the frame image, and the section of a frame image after the frame image as an independent angle-of-view movement section (an independent scene). In the example illustrated in FIG. 3, the section 310 is divided into the three partial sections 310a, 310b, and 310c. In this case, the angle-of-view movement section (the section 310) is divided into three angle-of-view movement sections. The control unit 201 may perform such division of the angle-of-view movement section (the scene) on the single frame image or all or some of the plurality of continuous frame images in which an object is not extracted in step S505. In a case where the above division of the angle-of-view movement section (the scene) is performed, the control unit 201 changes the information stored in step S504 to information regarding each scene. In this case, the number of scene IDs (the number of records in the scene list 400) increases to the number according to the number of divisions of the scenes. In this case, the processes of step S507 and subsequent steps are performed not on the original angle-of-view movement section, but on, for example, an angle-of-view movement section of which the start timing is the first among the plurality of angle-of-view movement sections newly created by dividing the angle-of-view movement section. The remaining angle-of-view movement sections among the angle-of-view movement sections may be subjected to the process of step S503 as angle-of-view movement sections that have not yet been extracted. In an angle-of-view movement section (a scene) where an object is not extracted among the angle-of-view movement sections (the scenes) divided as described above, it is determined that a particular object is not tracked (the determination is NO) in step S506.

For example, in step S506, the control unit 201 may divide the single angle-of-view movement section (the single scene) into a plurality of angle-of-view movement sections (scenes) based on the result of the individual identification.

For example, in a case where a plurality of objects different from each other is included as particular objects (e.g., people) in the region in focus in the angle-of-view movement section extracted in step S503, the control unit 201 may divide the single angle-of-view movement section (the single scene) into a plurality of angle-of-view movement sections (scenes) as described below. That is, the control unit 201 may divide the angle-of-view movement section extracted in step S503 into a plurality of angle-of-view movement sections with respect to each section where the same object is in focus, and determine the plurality of divided sections as new angle-of-view movement sections. In a case where the above division of the angle-of-view movement section (the scene) is performed, the control unit 201 changes the information stored in step S504 to information regarding each scene. In this case, the number of scene IDs (the number of records in the scene list 400) increases to the number according to the number of divisions of the scenes. In this case, the processes of step S507 and the subsequent steps are performed not on the original angle-of-view movement section, but on, for example, an angle-of-view movement section of which the start timing is the first among the plurality of angle-of-view movement sections newly created by dividing the angle-of-view movement section. The remaining angle-of-view movement sections among the angle-of-view movement sections may be subjected to the process of step S503 as angle-of-view movement sections that have not yet been extracted.

In a case where the same object is in focus in all the frame images included in the angle-of-view movement section extracted in step S503, it may be determined that the same object is tracked in the angle-of-view movement section, and the processes of step S507 and the subsequent steps may be performed. In a case where the same object is in focus in a predetermined proportion or more of frame images in all the frame images included in the angle-of-view movement section extracted in step S503, it may be by determined that the same object is tracked in the angle-of-view movement section, and the processes of step S507 and the subsequent steps may be performed. In a case where the same object is in focus in at least one frame in the first half of the angle-of-view movement section extracted in step S503 and at least one frame in the second half of the angle-of-view movement section, it may be determined the same object is tracked in the angle-of-view movement section. For example, in a case where the same object is in focus in the first frame and the last frame of the angle-of-view movement section extracted in step S503, it may be determined that the same object is tracked in the angle-of-view movement section, and the processes of step S507 and the subsequent steps may be performed. In this case, even in a case where the same object is in focus not in all the frame images included in the angle-of-view movement section extracted in step S503, the above division of the angle-of-view movement section may not be performed.

In a case where the feature amount of an individually identified object is frequently used in the image management application, the control unit 201 may store this feature amount as a template in the external storage device 204 and reuse the feature amount. For example, the control unit 201 may create a template image based on this feature amount and store the feature amount in the external storage device 204.

As a result of the determination in step S506, in a case where a particular object is tracked (YES in step S506), the process of step S507 is performed. In step S507, the control unit 201 compares an object ID issued for the object as described above and the object ID 404 of an angle-of-view movement section (a scene) one section before the angle-of-view movement section (the scene) as the processing target in the scene list 400. Based on the result of the comparison, the control unit 201 determines whether the object as the tracking target in the angle-of-view movement section (the scene) as the processing target and an object as a tracking target in the angle-of-view movement section (the scene) one section before the angle-of-view movement section (the scene) as the processing target are the same as each other.

As a result of the determination in step S507, in a case where the object as the tracking target in the angle-of-view movement section (the scene) as the processing target and the object as the tracking target in the angle-of-view movement section (the scene) one section before the angle-of-view movement section (the scene) as the processing target are the same as each other (YES in step S507), the process of step S508 is performed. In step S508, the control unit 201 includes the information regarding the angle-of-view movement section (the scene) as the processing target in information regarding the angle-of-view movement section (the scene) one section before the angle-of-view movement section (the scene) as the processing target in the scene list 400. For example, the control unit 201 changes information regarding the end position 403 of the angle-of-view movement section (the scene) one section before the angle-of-view movement section (the scene) as the processing target to the end timing of the angle-of-view movement section (the scene) as the processing target. The control unit 201 deletes the information (the scene ID 401, the start position 402, and the end position 403) stored in step S504 as the information regarding the angle-of-view movement section (the scene) as the processing target.

In step S509, the control unit 201 determines whether all the angle-of-view movement sections (the scenes) are extracted from the moving image as the analysis target. As a result of this determination, in a case where not all the angle-of-view movement sections (the scenes) are extracted (NO in step S509), the process of step S503 is performed again.

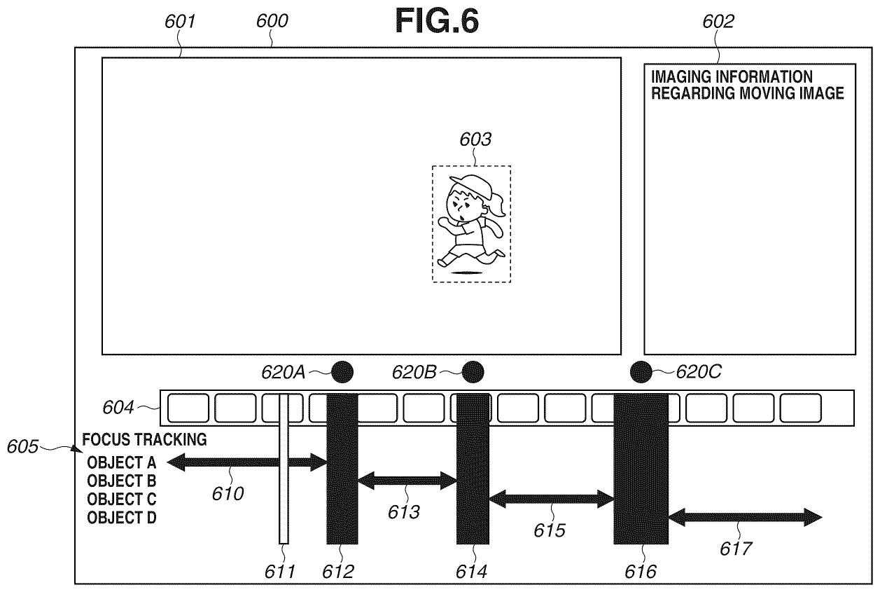

As a result of the determination in step S509, in a case where all the angle-of-view movement sections (the scenes) are extracted (YES in step S509), the process of step S510 is performed. In step S510, the control unit 201 performs a display process including displaying an image management screen for viewing and editing the moving image on a display unit (e.g., a computer display), performing processing according to an operation on the image management screen, and changing the display of the image management screen. The image management screen may be displayed on a terminal apparatus (the PC 104 or 105 or the mobile device 106), or may be displayed on the information processing apparatus 101 (the display unit 211). In a case where the image management screen is displayed on the terminal apparatus (the PC 104 or 105 or the mobile device 106), information regarding the image management screen may be transmitted (output) from the information processing apparatus 101 to the terminal apparatus. Information indicating the description of an operation on the image management screen may be transmitted (output) from the terminal apparatus to the information processing apparatus 101. The image management screen may be displayed in a case where the user 110 gives a display instruction, or may be automatically displayed by the control unit 201. A specific example of the image management screen will be described below with reference to FIG. 6.

After completion of the process of step S510, the processing in the flowchart in FIG. 5 ends. The process of step S510 may be performed as processing different from that in the flowchart in FIG. 5 (i.e., the process of step S510 may not be included in the flowchart in FIG. 5).

As a result of the determination in step S507, in a case where the object as the tracking target in the angle-of-view movement section (the scene) as the processing target and the object as the tracking target in the angle-of-view movement section (the scene) one section before the angle-of-view movement section (the scene) as the processing target are different from each other (NO in step S507), the process of step S511 is performed. In step S511, the control unit 201 stores the object ID 404 as the information regarding the angle-of-view movement section (the scene) as the processing target in addition to the information (the scene ID 401, the start position 402, and the end position 403) stored in step S504. The information stored as the object ID 404 may be an object ID issued in the process of step S506, or may be information associated with the feature amount. After completion of the process of step S511, the process of step S509 is performed.

As a result of the determination in step S506, in a case where a particular object is not tracked (NO in step S506), the process of step S512 is performed. In step S512, the control unit 201 determines whether objects as tracking targets (e.g., objects in regions in focus) change between angle-of-view movement sections (scenes) one section before and one section after the angle-of-view movement section (the scene) as the processing target. To make the determination in step S512, for example, the control unit 201 may extract an object as a tracking target from the angle-of-view movement section (the scene) one section after the angle-of-view movement section (the scene) as the processing target and perform individual identification based on the feature amount of the object on the angle-of-view movement section (the scene) one section after the angle-of-view movement section (the scene) as the processing target. For example, the extraction of an object as a tracking target and the individual identification based on the feature amount of the object may be performed as described in steps S505 and S506. After the processes of steps S503, S504, and S505 and the individual identification in step S506 are performed on all the angle-of-view movement sections (the scenes) included in the moving image, the processes of steps S507 and S512 may be performed. In this case, the processes of steps S506 to S512 may be repeated based on the result of the determination in step S509. In a case where the process of dividing the angle-of-view movement section (the scene) into a plurality of angle-of-view movement sections (scenes) is performed between steps S505 and S506, the determination in step S512 may be made.

As a result of the determination in step S512, in a case where objects as tracking targets do not change between the angle-of-view movement sections (the scenes) one section before and one section after the angle-of-view movement section (the scene) as the processing target (NO in step S512), the control unit 201 determines that the angle-of-view movement section (the scene) as the processing target is not an unnecessary scene. In this case, the process of step S509 is performed. In this case, the control unit 201 may store “FALSE” in the scene necessity 405 as the information regarding the angle-of-view movement section (the scene) as the processing target in addition to the information (the scene ID 401, the start position 402, and the end position 403) stored in step S504.

In a case where the determination is NO in step S512, the control unit 201 may determine the three angle-of-view movement sections, namely the angle-of-view movement section (the scene) as the processing target and the angle-of-view movement sections (the scenes) one section before and one section after the angle-of-view movement section (the scene) as the processing target, as a single angle-of-view movement section (a single scene).

On the other hand, as a result of the determination in step S512, in a case where objects as tracking targets change between the angle-of-view movement sections (the scenes) one section before and one section after the angle-of-view movement section (the scene) as the processing target (YES in step S512), the process of step S513 is performed. In step S513, the control unit 201 stores “TRUE” in the scene necessity 405 as the information regarding the angle-of-view movement section (the scene) as the processing target in addition to the information (the scene ID 401, the start position 402, and the end position 403) stored in step S504. Then, the process of step S509 is performed.

For example, the following determination may be made between steps S512 and S513. That is, the control unit 201 determines whether the differences between the direction in which the angle of view moves in the angle-of-view movement section (the scene) as the processing target and the directions in which the angle of view moves in the angle-of-view movement sections (the scenes) one section before and one section after the angle-of-view movement section as the processing target are within a predetermined range. In this determination, for example, the control unit 201 may use only the angle-of-view movement section (the scene) one section before the angle-of-view movement section as the processing target instead of the angle-of-view movement sections (the scenes) one section before and one section after the angle-of-view movement section as the processing target.

Instead of determining whether the differences are within the predetermined range, the control unit 201 may determine whether there are differences between the directions. As a result of this determination, in a case where the differences between the directions in which the angle of view moves are not within the predetermined range, it may be determined that the angle-of-view movement section (the scene) as the processing target is an unnecessary scene, and the process of step S513 may be performed. If, on the other hand, the differences between the directions in which the angle of view moves are within the predetermined range, it may be determined that the angle-of-view movement section (the scene) as the processing target is not an unnecessary scene. Then, the process of step S513 may not be performed, and the process of step S509 may be performed. The process of step S512 may not be performed, and it may be determined whether the differences between the directions in which the angle of view moves are within the predetermined range. In this case, for example, in a case where the determination is NO in step S506, the control unit 201 may determine whether the differences between the directions in which the angle of view moves are within the predetermined range, instead of the determination in step S512.

### Example of Image Management Screen

FIG. 6 is a diagram illustrating an example of an image management screen 600. For example, the image management screen 600 is a screen for viewing and editing a moving image managed by the image management application. The image management screen 600 can present a scene where an object is tracked and a scene where no object is tracked in the moving image to the user 110 in an easily understandable manner. As described above, a display process on the image management screen 600 illustrated in FIG. 6 is performed in step S510 in FIG. 5, for example.

For example, the control unit 201 refers to the scene list 400 illustrated in FIG. 4, creates information required to display the image management screen 600, and displays the image management screen 600 on a display unit. The display unit may be the display unit 211 or the display unit of a terminal apparatus (the PC 104 or 105 or the mobile device 106). In a case where the image management screen 600 is displayed on the display unit 211, the control unit 201 may cause the VRAM 207 to create the image management screen 600.

In FIG. 6, a display region 601 is a region where a moving image as a processing target is reproduced and displayed.

A display region 602 is a region where information regarding metadata of a file of the moving image as the processing target is displayed.

A region 603 is a region in focus in a frame image that is being reproduced in the moving image as the processing target. A case is illustrated where the object 302 illustrated in FIG. 3 is in focus.

A thumbnail list 604 is a list of thumbnails of individual frame images included in the moving image.

An object list 605 is a list of identification information (object IDs) of objects in focus in the moving image. For example, the information displayed in the object list 605 is created based on the information stored in the object ID 404 in the scene list 400. FIG. 6 illustrates a case where the pieces of identification information regarding the objects 302, 303, 304, and 305 illustrated in FIG. 3 are A, B, C, and D, respectively.

A tracking section 610 is an angle-of-view movement section (a scene) where the object 302 (the object A) is subjected to tracking imaging. FIG. 6 illustrates a case where the tracking section 610 is indicated by a double-headed arrow. The tracking section 610 indicates that thumbnails displayed above the double-headed arrow indicating the tracking section 610 are thumbnails of the scene where the object 302 is tracked. The range of the tracking section 610 is derived based on the start position 402 and the end position 403 associated with the object ID 404 of this scene in the scene list 400. The tracking section 610 corresponds to the section 310 illustrated in FIG. 3.

In the example illustrated in FIG. 3, the object 302 (the object A) is tracked from the starting position 307 to the goal position 308. Then, while the object 302 moves from the goal position 308 to the post-contest waiting place 309, the focus is temporarily interrupted. FIG. 6 illustrates a case where this state is displayed as a tracking interruption section 611 in the middle of the tracking section 610. The tracking interruption section 611 corresponds to the partial section 310b illustrated in FIG. 3. Objects in focus in sections one section before and one section after the tracking interruption section 611 are the object 302 (the object A). In this case, as described with reference to the flowchart in FIG. 5, it is determined that the tracking interruption section 611 is not an unnecessary scene (the determination is NO in step S512). Thus, the control unit 201 displays the tracking interruption section 611 and the sections one section before and one section after the tracking interruption section 611 as a single section (a scene where the object 302 is tracked).

A non-tracking section 612 is a section where tracking imaging is not performed (a section where the angle of view of the imaging apparatus 107 is continuously moving in the state where no particular object is in focus) in the moving image. FIG. 6 illustrates a case where the non-tracking section 612 is indicated by a black-filled rectangle. The non-tracking section 612 is derived based on the scene necessity 405 in the scene list 400. Specifically, the range of the non-tracking section 612 is derived based on the start position 402 and the end position 403 in a record (a scene) where the scene necessity 405 is “TRUE”. The non-tracking section 612 corresponds to the section 311 illustrated in FIG. 3.

In the example illustrated in FIG. 3, after the object 302 (the object A) is tracked, the object 303 (the object B) is tracked in a next scene. In this case, objects change between the tracking section 610 one section before the non-tracking section 612 and a tracking section 613 one section after the non-tracking section 612. Thus, as described with reference to the flowchart in FIG. 5, it is determined that the non-tracking section 612 is an unnecessary scene (the determination is YES in step S512).

In FIG. 6, the tracking section 613 is a section (a scene) where the object 303 (the object B) is subjected to tracking imaging. The range of the tracking section 613 is derived based on the start position 402 and the end position 403 associated with the object ID 404 of this scene in the scene list 400. The tracking section 613 corresponds to the section 312 illustrated in FIG. 3.

In the example illustrated in FIG. 3, the object 303 (the object B) is tracked from the starting position 307 to the goal position 308. No object is in focus in sections one section before and one section after the tracking section 613. Thus, it is determined that objects do not change between the sections one section before and one section after the tracking section 613 (the determination is NO in step S512). Thus, it is not determined that the series of scenes where the object 303 is tracked is an unnecessary scene.

A non-tracking section 614 is a section where tracking imaging is not performed in the moving image. The non-tracking section 614 is derived based on the scene necessity 405 in the scene list 400. Specifically, the range of the non-tracking section 614 is derived based on the start position 402 and the end position 403 in a record (a scene) where the scene necessity 405 is “TRUE”. The non-tracking section 614 corresponds to the section 313 illustrated in FIG. 3.

In the example illustrated in FIG. 3, after the object 303 (the object B) is tracked, the object 304 (the object C) is tracked in a next scene. In this case, objects change between the tracking section 613 one section before the non-tracking section 614 and a tracking section 615 one section after the non-tracking section 614. Thus, as described with reference to the flowchart in FIG. 5, it is determined that the non-tracking section 614 is an unnecessary scene (the determination is YES in step S512).

Similarly, the tracking section 615 and a tracking section 617 are sections where the object 304 (the object C) and the object 305 (the object D), respectively, are subjected to tracking imaging. A non-tracking section 616 is a section where tracking imaging is not performed in the moving image. Objects change between the tracking section 615 one section before the non-tracking section 616 and the tracking section 617 one section after the non-tracking section 616. Thus, it is determined that the non-tracking section 616 is an unnecessary scene.

In the present embodiment, a case is illustrated where delete buttons 620A to 620C are displayed on the image management screen 600 illustrated in FIG. 6. FIG. 6 illustrates a case where the delete buttons 620A to 620C are displayed for the respective unnecessary scenes. Specifically, FIG. 6 illustrates a case where the delete buttons 620A, 620B, and 620C are GUIs that are operated by the user 110 to delete the non-tracking sections 612, 614, and 616, respectively. In response to the delete button 620A, 620B, or 620C being pressed, the control unit 201 deletes a frame image of the angle-of-view movement section (the non-tracking section) corresponding to the pressed delete button from the moving image. The control unit 201 may delete information regarding the angle-of-view movement section (the non-tracking section) from the scene list 400. It is possible to easily perform the work of editing the moving image by using the delete buttons 620A to 620C.

The non-tracking sections 612, 614, and 616 are deleted from the moving image, whereby it is possible to continuously present to the user 110 a moving image in which objects in focus switch in the state where the objects remain in focus.

For example, the control unit 201 may automatically delete an unnecessary scene from the moving image. In this case, the control unit 201 may display, on the image management screen 600, information indicating that the unnecessary scene is deleted from the moving image and information that identifies a section where the deleted unnecessary scene has been present. The control unit 201 may display on the image management screen 600 a GUI that is operated by the user 110 to return the deleted unnecessary scene to the moving image. Based on an operation on the GUI, the control unit 201 may return the deleted unnecessary scene to the moving image.

As described above, in the present embodiment, a case is illustrated where a processing device is achieved by using the information processing apparatus 101. As described above, in the example illustrated in FIG. 3, the information regarding the scene necessity 405 in the sections of which the scene ID 401 illustrated in FIG. 4 is “310” and “312” (the tracking sections 610 and 613) is an example of first section information. The information regarding the scene necessity 405 in the sections of which the scene ID 401 illustrated in FIG. 4 is “311” and “313” (the non-tracking sections 612 and 614) is an example of second section information. The delete buttons 620A to 620C are examples of operation information.

As described above, in the present embodiment, the information processing apparatus 101 extracts a section where the angle of view of the imaging apparatus 107 continuously moves from a moving image captured by the imaging apparatus 107. Then, the information processing apparatus 101 derives information (e.g., an object ID) indicating a description according to the feature of an object in this section. Then, based on this information, the information processing apparatus 101 derives information for identifying the state where the section included in the moving image is a section where an object is tracked, or information for identifying the state where the section included in the moving image is a section where no object is tracked. Thus, conventionally, it is not possible to distinguish an individual section (an individual scene) by using individual identification of an object, whereas in the present embodiment, it is possible to associate an individual section with the feature of an object.

Thus, it is possible to improve the accuracy of the distinction of whether a scene is a scene where an imaging apparatus tracks an object. Consequently, for example, even in a case where the tracking of an object is temporarily interrupted in a moving image, the information processing apparatus 101 can determine scenes where the same object is tracked as a single scene with high accuracy. For example, the information processing apparatus 101 can automatically search for and filter an unnecessary scene between the scenes where the object is tracked. In this case, it is possible to reduce the trouble of the work of editing the moving image.

In the present embodiment, for example, the information processing apparatus 101 displays on a display unit the image management screen 600 including the non-tracking sections 612, 614, and 616 as information for identifying the state where sections included in a moving image are sections where no object is tracked. The information processing apparatus 101 displays on the image management screen 600 the delete buttons 620A to 620C for deleting the non-tracking sections 612, 614, and 616, respectively. Thus, it is possible to reduce the trouble of the work of deleting an unnecessary scene.

In the present embodiment, in a case where information indicating a description according to the feature of an object in a section where the angle of view continuously moves and information indicating a description according to the feature of an object in a section one section before this section are the same as each other, the information processing apparatus 101 determines these sections as a single section. Thus, it is possible to automatically put scenes of the same object together.

In the present embodiment, in a case where the derivation of information indicating a description according to the feature of an object fails in a section where the angle of view continuously moves, the information processing apparatus 101 refers to information indicating a description according to the feature of an object in sections before and after this section. Then, based on the referred-to information, the information processing apparatus 101 determines whether the section where the derivation of information indicating a description according to the feature of an object fails is a section where an object is tracked. Thus, it is possible to determine whether the section where the derivation of information indicating a description according to the feature of an object fails is merely a section where the tracking of an object is temporarily interrupted, and is a part of a section where the tracking of the object continues, with higher accuracy.

In the present embodiment, in a case where objects as tracking targets change in a single section extracted as a section where the angle of view continuously moves, the information processing apparatus 101 divides this section into a plurality of sections. Thus, it is possible to automatically divide a section set as a section where the angle of view continuously moves into sections with respect to each tracked object.

In the present embodiment, based on the feature amount of an object in a section where the angle of view continuously moves, the information processing apparatus 101 derives identification information regarding the object. Thus, it is possible to cause a user to easily identify an object as a tracking target in each of sections where the angle of view continuously moves.

The embodiment of the present disclosure described above are merely examples of specific implementations for carrying out the disclosure. The embodiment should not be construed as limiting the technical scope of the present disclosure. In other words, the present disclosure can be implemented in various forms without departing from its technical concept or essential features.

According to the present disclosure, it is possible to improve the accuracy of the distinction of whether a scene is a scene where an imaging apparatus tracks an object.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-098012, filed Jun. 18, 2024, which is hereby incorporated by reference herein in its entirety.

What is claimed is:

1. A processing device comprising:
one or more memories; and
one or more processors in communication with the one or more memories, wherein the one or more processors and the one or more memories are configured to:
extract, from a captured moving image, a section where an angle of view of an imaging apparatus continuously moves;
derive object information indicating a description according to a feature of an object in the extracted section;
derive, based on the derived object information, first section information for identification of a state where the section included in the moving image is a section where an object is tracked, or second section information for identification of a state where the section included in the moving image is a section where no object is tracked; and
output the second section information.

2. The processing device according to claim 1, wherein the one or more processors and the one or more memories are further configured to:
delete a moving image of a section identified by the second section information from the moving image; and
display, on a display unit, the second section information and operation information that is operated to delete the moving image of the section identified by the second section information, and
delete the moving image of the section identified by the second section information, based on an operation performed on the operation information.

3. The processing device according to claim 1, wherein based on the object information regarding the section where the angle of view of the imaging apparatus continuously moves and the object information regarding at least one of sections before and after the section, the first or second section information regarding at least one of the section and the at least one of the sections before and after the section is derived.

4. The processing device according to claim 1, wherein in a case where the object information regarding the section where the angle of view of the imaging apparatus continuously moves and the object information regarding a section which is one section before the section are the same as each other, the section and the section which is one section before the section are determined as a single section, and the first or second section information regarding the single section is derived.

5. The processing device according to claim 1, wherein the one or more processors and the one or more memories are further configured to:
determine, based on the object information regarding the extracted section, whether the section is a section where an object is tracked; and
derive the first section information in a case where it is determined that the section is a section where an object is tracked, and derive the second section information in a case where it is determined that the section is a section where no object is tracked.

6. The processing device according to claim 5, wherein in a case where the object information is not derived in the section where the angle of view of the imaging apparatus continuously moves, then based on the object information regarding sections before and after the section where the object information is not derived, it is determined whether the section where the object information is not derived is a section where an object is tracked.

7. The processing device according to claim 1, wherein the one or more processors and the one or more memories are further configured to divide, based on the derived object information, in a case where objects as tracking targets change in a single section where the angle of view of the imaging apparatus continuously moves, the section into a plurality of sections.

8. The processing device according to claim 1, wherein based on a feature amount of an object in the extracted section, identification information regarding the object is derived as the object information.

9. The processing device according to claim 1, wherein the object information is information indicating a description according to a feature of an object in a region including a position in focus in the moving image.

10. A processing method comprising:
extracting, from a captured moving image, a section where an angle of view of an imaging apparatus continuously moves;
deriving, as first deriving, object information indicating a description according to a feature of an object in the extracted section;
deriving, based on the derived object information, first section information for identification of a state where the section included in the moving image is a section where an object is tracked, or second section information for identification of a state where the section included in the moving image is a section where no object is tracked; and
outputting the second section information.

11. A computer-readable recording medium recording a program for causing a computer to execute a processing method comprising:
extracting, from a captured moving image, a section where an angle of view of an imaging apparatus continuously moves;
deriving, as first deriving, object information indicating a description according to a feature of an object in the extracted section;
deriving, based on the derived object information, first section information for identification of a state where the section included in the moving image is a section where an object is tracked, or second section information for identification of a state where the section included in the moving image is a section where no object is tracked; and
outputting the second section information.
